(19) United States
(12) Patent Application Publication
(10) Pub. No.: US 2017/0310021 A1
(43) Pub. Date: Oct. 26, 2017

(54) TERMINAL MEMBER ASSEMBLY

(71) Applicant: Sumitomo Wiring Systems, Ltd., Yokkaichi, Mie (JP)

(72) Inventors: Takahiro Tsuchiya, Yokkaichi, Mie (JP); Takashi Tsuchiya, Yokkaichi, Mie (JP); Yuji Kitagawa, Yokkaichi, Mie (JP); Yuichi Goto, Yokkaichi, Mie (JP)

(21) Appl. No.: 15/516,051

(22) PCT Filed: Sep. 16, 2015
(86) PCT No.: PCT/JP2015/076247

§ 371 Date: Mar. 31, 2017

(30) Foreign Application Priority Data
Oct. 7, 2014 (JP) 2014-206131

(51) Int. Cl. H01R 4/24; H01R 33/945; H01R 24/38; H01R 33/88; H01R 33/975; H01R 33/97

(52) U.S. Cl. CPC H01R 4/2425; H01R 33/975; H01R 33/97; H01R 24/38; H01R 33/88; H01R 33/9453

(57) ABSTRACT

A terminal member assembly 1 has ground terminals (10A, 10B) each including a main body (20) in the form of a flat plate. A coupling (30) extends from the main body (20) and a wire connecting portion (40) is connected to an extending end of the coupling (30). The ground terminals (10A, 10B) are assembled with each other with the main bodies (20) overlapping each other. At least one (10A) of the ground terminals includes an overlap area (30A) to be overlapped with the coupling (30) of the other ground terminal (10B). The overlap area is located on a surface of the coupling (30) facing the adjacent other ground terminal (10B). A contact portion (36) is located in the overlap area (30A) and projects toward the coupling (30) of the other ground terminal (10B) and is configured to contact the coupling (30) of the other ground terminal (10B).

### BACKGROUND

### 1. Field of the Invention

This specification relates to a terminal member assembly.

### 2. Description of the Related Art

Japanese Unexamined Patent Publication No. 2009-32456 discloses a terminal member assembly that fixes a plurality of terminal fittings by overlapping and assembling the terminal fittings. Each terminal fitting includes a mounting hole, through which a bolt is to be inserted for collectively bolting the terminal fittings.

However, an operator may forget to tighten a bolt with the above-described terminal member assembly or a contact pressure between the terminal fittings may be insufficient and electrical connection reliability may be reduced if the bolt is tightened with an insufficient tightening force.

### SUMMARY

This specification is directed to a terminal member assembly with a plurality of terminal fittings. Each terminal fitting includes a main body in the form of a flat plate, a coupling extending from the main body and a wire connecting portion connected to an extending end of the coupling. The terminal fittings are assembled together with the main bodies overlapping each other. At least one of the terminal fittings includes an overlap area to be overlapped with the coupling of an adjacent terminal fitting. The overlap area is located on a surface of the coupling facing the other terminal fitting. A contact portion is located in the overlap area to project toward the coupling of the other terminal fitting and is configured to contact the coupling of the other terminal fitting.

According to the above configuration, the adjacent terminal fittings are held in contact with each other by the contact portion. Thus, electrical connection reliability between the adjacent terminal fittings can be ensured even if there is a trouble in bolt tightening.

The coupling includes the overlap area and the contact portion is arranged in this overlap area. Thus, the contact portion is surrounded by areas of the main body, the wire connecting portion and the coupling of the terminal fitting other than the overlap area. According to this configuration, even if terminal member assemblies collide with each other, such as during the transportation of the terminal member assemblies, a possibility of the contact portion surrounded by the other parts to directly receive an impact is low. In this way, the contact portion will not be deformed to reduce electrical connection reliability between the terminal fittings.

The one terminal fitting may include a reinforcing portion arranged on the coupling and projecting toward the other terminal fitting. The contact portion may be connected to the reinforcing portion. According to this configuration, the contact portion is connected to the reinforcing portion. Thus, the contact portion and the reinforcing portion can be formed in the same operation step and a manufacturing step can be simplified.

According to the technique disclosed by this specification, it is possible to ensure electrical connection reliability between terminal fittings constituting a terminal member assembly.

### BRIEF DESCRIPTION OF DRAWINGS

FIG. 1 is a perspective view of a terminal member assembly of an embodiment.

FIG. 2 is a front view of the terminal member assembly of the embodiment.

FIG. 3 is a back view of the terminal member assembly of the embodiment.

FIG. 4 is a section along A-A of FIG. 2.

FIG. 5 is a view showing a bolt arrangement area in the terminal member assembly of the embodiment.

FIG. 6 is a perspective view of a ground terminal of the embodiment.

### DETAILED DESCRIPTION

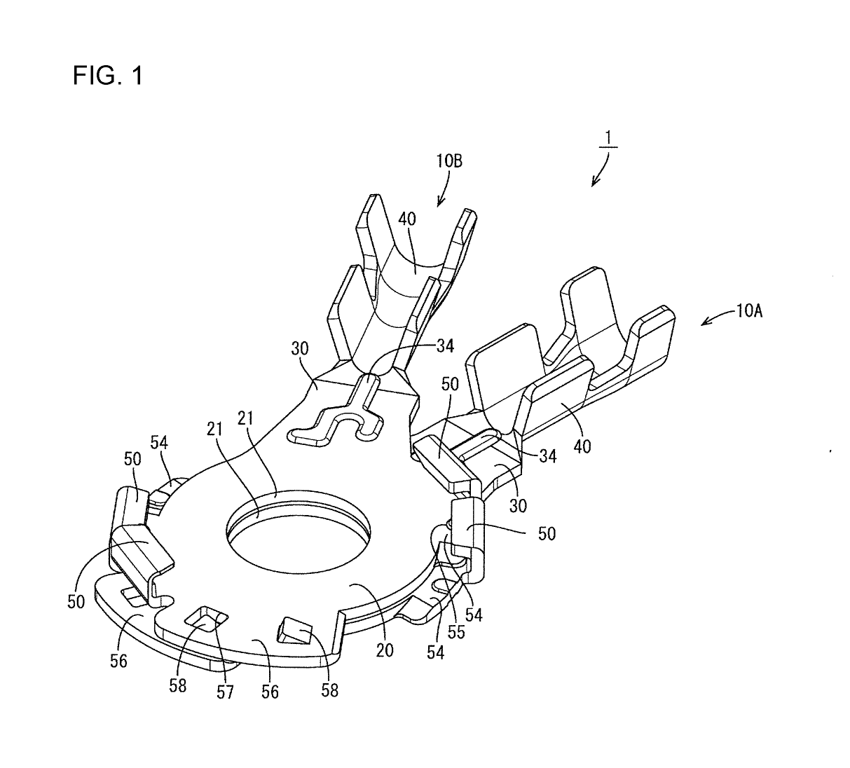

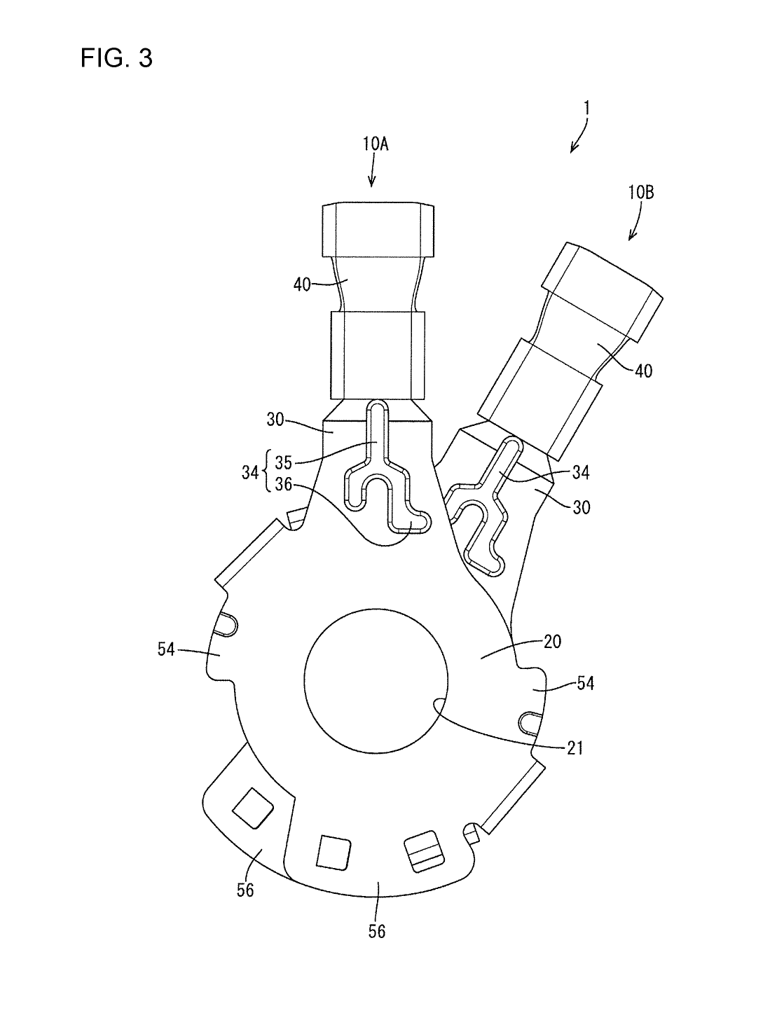

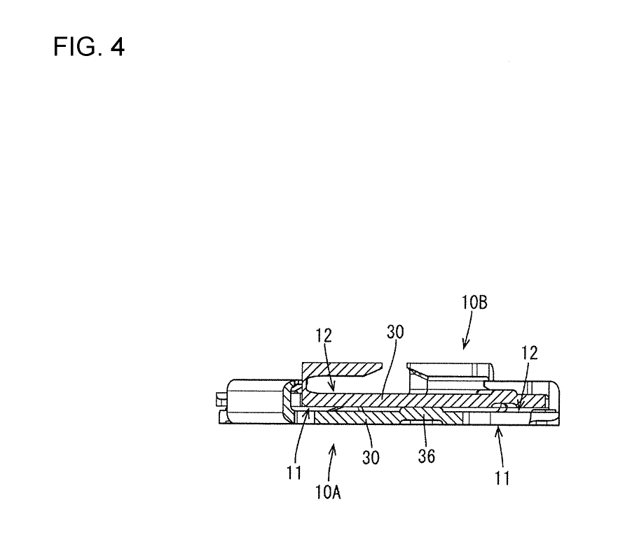

An embodiment of the invention is described with reference to FIGS. 1 to 6. A terminal member assembly 1 of this embodiment is to ground devices installed in a vehicle and includes, as shown in FIG. 1, two ground terminals 10A, 10B (corresponding to terminal fittings). The two ground terminals 10A, 10B are connected respectively to ends of unillustrated ground wires pulled out from the respective devices and mounted on a body of the unillustrated vehicle while being assembled with each other.

The two ground terminal 10A is to be arranged in contact with the body when being mounted on the body, and the ground terminal 10B is to be arranged more distant from the body than the ground terminal 10A. The two ground terminals 10A, 10B are shaped identically. Thus, components of the ground terminal 10A are described in detail below. components of the ground terminal 10B are denoted by the same reference signs, but are not described in detail.

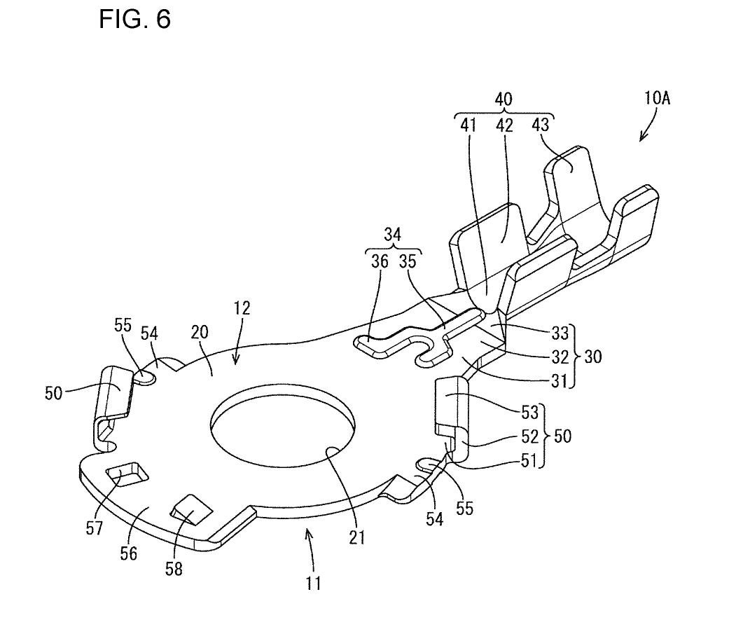

As shown in FIG. 6, the ground terminal 10A is formed by applying bending, punching and beating to a metal plate material punched out into a predetermined shape. The ground terminal 10A has a ground surface 11 facing toward the body when the terminal member assembly 1 is mounted on the body, and a wire arrangement surface 12 on which the wire connected to this ground terminal 10A is arranged. The ground terminal 10A includes a main body 20 and a wire connecting portion 40 connected to the main body portion 20 via a coupling 30.

The main body 20 is a substantially circular flat plate and includes a circular bolt insertion hole 21 penetrating from one plate surface to the other plate surface in a center. This bolt insertion hole 21 is configured to allow insertion of a shaft of an unillustrated bolt.

The coupling 30 is a flat plate extending radially out from the outer peripheral edge of the main body 20 and is arranged on the same plane as the main body 20. The coupling 30 includes a first width changing portion 31 connected to the main body 20 and gradually narrows in width at farther distances from the main body 20. A straight portion 32 is connected to the first width changing portion 31 and has a constant width. A second width changing portion 33 is connected to the straight portion 32 and gradually narrows in width at farther distances from the straight portion 32 and leads to the wire connecting portion 40.

The wire connecting portion 40 includes a long and narrow bottom wall 41 connected to the coupling 30 and extending toward a side opposite to the main body 20. Two wire barrels 42 rise respectively from two sides of this bottom wall 41 and two insulation barrels 43 rise respectively from the sides of the bottom wall 41. The wire barrels 42 and the insulation barrels 43 rise from the bottom wall 41 on the side of the wire arrangement surfaces 12. The wire barrels 42 are arranged closer to the coupling 30 than the insulation barrels 43. The wire barrels 42 are to be crimped to a core exposed from an insulation coating at an end of the wire (not shown), and the insulation barrels 43 are to be crimped to a part of the wire where the core is covered with the insulation coating.

As shown in FIG. 1, the ground terminals 10A and 10B are assembled by overlapping the main bodies 20 such that the positions of the bolt insertion holes 21 coincide with each other and rotating the ground terminal 10B relative to the ground terminal 10A in a circumferential direction of the main body portion 20 about the center of the main body 20, i.e. a position where the bolt insertion hole 21 is formed.

As shown in FIG. 6, the ground terminal 10A includes two clamping portions 50 connected to the main body 20, two clamped pieces 54 and a locking plate 56. These are parts for holding the two ground terminals 10A, 10B in a state assembled with each other.

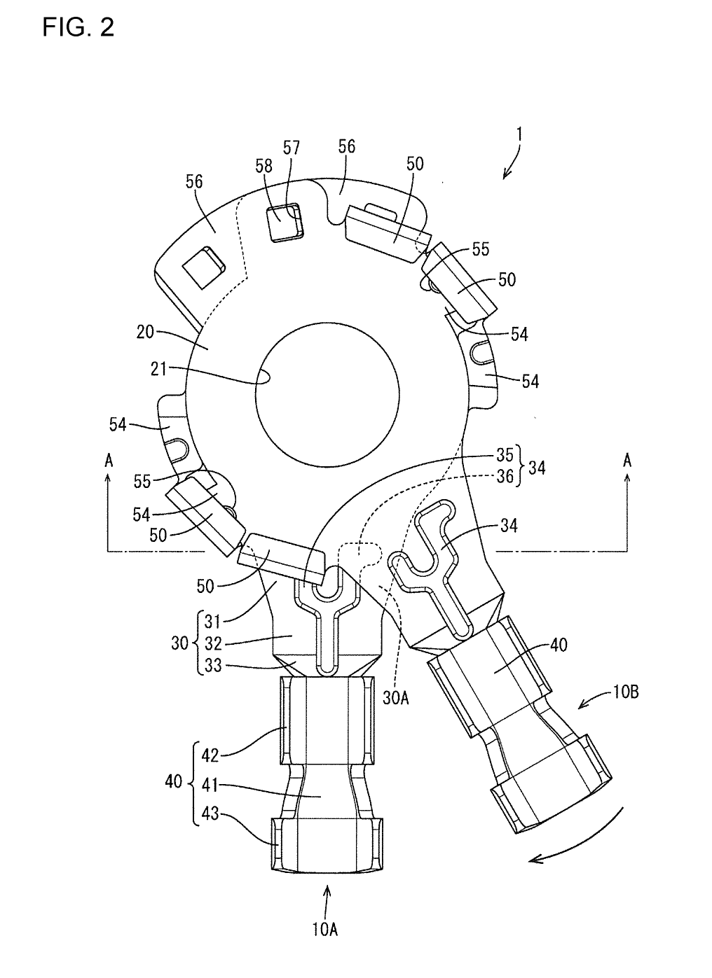

The clamping portions 50 are arranged on opposite sides across the bolt insertion hole 21 (center of the main body 20). One clamping portion 50 is arranged near the coupling 30 and the other is arranged at a distance from the coupling 30. The clamping portion 50 near the coupling 30 is forward of the coupling 30 in a clockwise direction on the outer peripheral edge of the main body 20 when the ground terminal 10A is viewed from the side of the wire arrangement surface 12 (from a side in front of the plane of FIG. 2).

Each clamping portion 50 includes a base 51, a rising wall 52 and a pressing piece 53. The base 51 extends out from the outer peripheral edge of the main body 20 and is arranged on the same plane as the main body 20. The rising wall 52 is arranged along an extending end of the base 51 and rises perpendicularly to the base 51. The rising wall 52 is arranged on the side of the wire arrangement surface 12 with respect to the base 51. The pressing piece 53 extends inward parallel to the base 51 from a rising end of the rising wall 52.

The clamped pieces 54 are to be clamped by the clamping portions 50 of the mating ground terminal 10B when the two ground terminals 10A, 10B are assembled. Each of the clamped pieces 54 is a plate-like part extending out from the outer peripheral edge of the main body 20 and is arranged on the same plane as the main body 20. Each clamped piece 54 is adjacent to the base 51 in each of the clamping portions 50, and is located forward of the clamping portion 50 in the clockwise direction on the outer peripheral edge of the main body 20 when the ground terminal 10A is viewed from the side of the wire arrangement surface 12 (from the side in front of the plane of FIG. 2).

Each clamped piece 54 includes a press-fitting portion 55. The press-fitting portion 55 is for ensuring electrical connection between the two ground terminals 10A, 10B by contacting the clamping portion 50 when the clamped piece 54 is clamped by the clamping portion 50. The press-fitting portion 55 is formed by a bulging part of the clamped piece 54 on the side of the wire arrangement surface 12 and, in this embodiment, is formed by beating, embossing or deforming a part of the clamped piece 54.

The locking plate 56 extends out from the outer peripheral edge of the main body 20, is arranged on the same plane as the main body 20 and is located on a side opposite to the coupling 30 and the wire connecting portion 40 across the bolt insertion hole 21 (center of main body 20).

The locking plate 56 includes a locking hole 57 and a locking piece 58 that restrict rotation of the two ground terminals 10A, 10B from a proper assembled position in disassembling directions. The locking hole 57 is a rectangular through hole penetrating from one plate surface to the other plate surface of the locking plate 56. The locking piece 58 is a protrusion projecting from the plate surface of the locking plate 56 and is arranged on the side of the wire arrangement surface 12 in the locking plate 56. The locking piece 58 is located rearward of the locking hole 57 in the clockwise direction when the ground terminal 10A is viewed from the side of the wire arrangement surface 12.

The coupling 30 includes a projection 34. The projection 34 includes a reinforcing portion 35 and a contact portion 36 connected to the reinforcing portion 35. The reinforcing portion 35 reinforces the coupling 30 so that the coupling 30 is hard to bend, and the contact portion 36 ensures electrical connection between the two ground terminals 10A, 10B by contacting the coupling 30 of the mating ground terminal 10B when the ground terminal 10A is assembled with the ground terminal 10B. The projection 34 is formed by a bulging part of the coupling 30 on the side of the wire arrangement surface 12 and, in this embodiment, formed by beating, embossing or deforming a part of the coupling 30.

The reinforcing portion 35 has a Y shape with a forked side facing toward the main body 20, and is arranged at a center position between two side edges of the coupling 30. A vertical bar part of the Y shape of the reinforcing portion is arranged on the second width changing portion 33 and the straight portion 32 and a forked part is arranged on the first width changing portion 31. The contact portion 36 is extends toward the main body 20 from the tip of one of two branches of the Y-shaped reinforcing portion 35 and extends farther out (toward a side opposite to the other branch) in a direction perpendicular to an extending direction of the coupling 30 from the tip of the part extending toward the main body 20. More specifically, the reinforcing portion 35 extends rearward in the clockwise direction when the ground terminal 10A is viewed from the side of the wire arrangement surface 12, i.e. in a direction opposite to the clamping portion 50 arranged near the coupling 30. The outer edges of the projection (reinforcing portion 35 and contact portion 36) are slightly inward of and at a distance from the side edges of the coupling 30.

The coupling 30 of the ground terminal 10A includes, on a surface facing the mating ground terminal 10B (wire arrangement surface 12), an overlap area 30A to be overlapped with the coupling 30 of the ground terminal 10B when the ground terminal 10A is assembled with the ground terminal 10B, and the reinforcing portion 35 is arranged in this overlap area 30A.

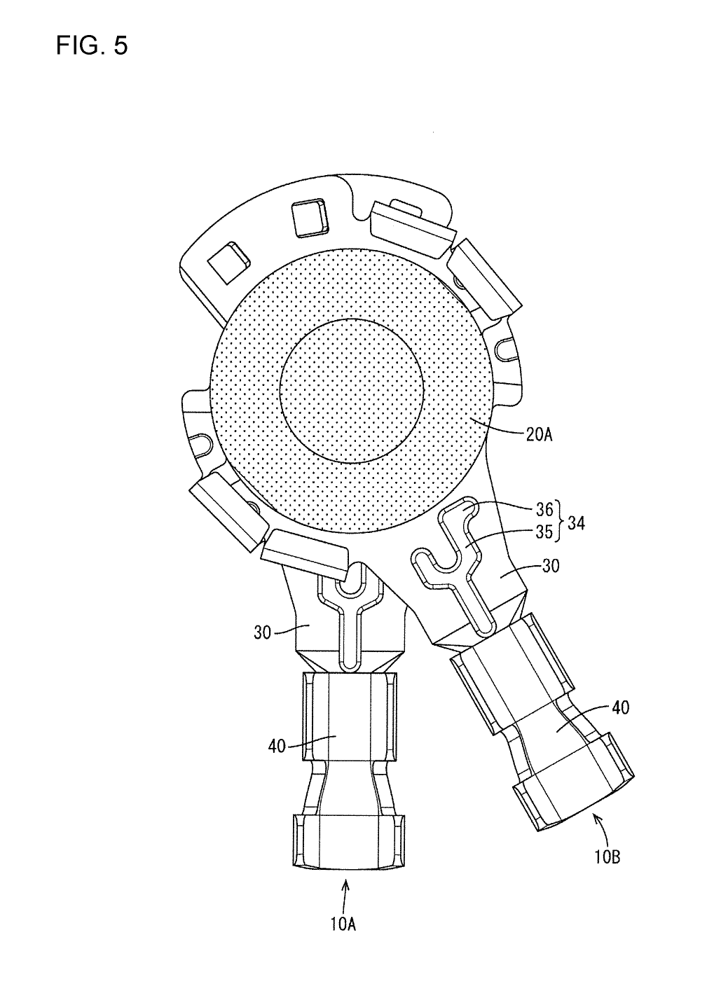

Note that the projections 34 are arranged outside a bolt arrangement area 20A (shaded area in FIG. 5) where the bolt is arranged in the ground terminals 10A, 10B when the terminal member assembly 1 is mounted on the body.

Next, the procedure of assembling the two ground terminals 10A, 10B is described.

First, the ground terminals 10A, 10B are swaged to the wires. Subsequently, the main body 20 of the ground terminal 10B is placed on the main body 20 of the ground terminal 10A while aligning the positions of the bolt insertion holes 21. At this time, the ground terminals 10A, 10B are arranged such that the wire arrangement surface 12 of the ground terminal 10A and the ground surface 11 of the ground terminal 10B face each other. Further, the ground terminals 10A, 10B are arranged so that the respective clamped pieces 54 of the ground terminal 10B are adjacent to and behind the respective clamping portions 50 of the ground terminal 10A in the clockwise direction when the ground terminals 10A, 10B are viewed from the side of the wire arrangement surfaces 12.

From this state, the ground terminals 10A, 10B are rotated. At this time, the ground terminal 10B is rotated relative to the ground terminal 10A in the clockwise direction (arrow direction of FIG. 2) when viewed from the side of the wire arrangement surface 12. Then, the respective clamped pieces 54 of the ground terminal 10B are inserted between the bases 51 and the pressing pieces 53 of the respective clamping portions 50 of the ground terminal 10A. Here, an interval between the base portions 51 and the pressing pieces 53 is substantially equal to a plate thickness of the clamped pieces 54 and the clamped pieces 54, and slips into the clamping portions 50 while pushing up the pressing pieces 53 by a height of the press-fitting portions 55 since the clamped pieces 54 include the press-fitting portions 55. In this way, the clamped pieces 54 of the ground terminal 10A and the clamping portions 50 of the ground terminal 10B are held in contact to electrically connect the ground terminals 10A, 10B.

When the ground terminals 10A, 10B reach the proper assembled position, the clamping portions 50 of the ground terminal 10B contact with the clamping portions 50 of the ground terminal 10A, thereby restricting any further rotation of the ground terminals 10A, 10B from the proper assembled position. Simultaneously with this, the locking piece 58 of the ground terminal 10A is fit into the locking hole 57 of the ground terminal 10B and the projecting end edge of the locking piece 58 and the hole edge of the locking hole 57 are locked to each other, thereby restricting rotation of the both ground terminals 10A, 10B from the proper assembled position in the disassembling directions.

With the ground terminals 10A, 10B at the proper assembled position, the overlap area 30A on the coupling 30 of the ground terminal 10A partly overlaps the coupling 30 of the ground terminal 10B. Then, the contact portion 36 of the ground terminal 10A contacts the coupling 30 of the ground terminal 10B and the ground terminals 10A, 10B are connected electrically.

As described above, in this embodiment, the assembled two ground terminals 10A, 10B are held in contact with each other by the press-fitting portions 55 and the contact portion 36. Thus, electrical connection reliability between the ground terminals 10A, 10B can be ensured even if there is a trouble in bolt tightening when the terminal member assembly 1 is mounted on the body.

Particularly, the coupling 30 of the ground terminal 10A includes, on the surface facing the mating ground terminal 10B (wire arrangement surface 12), the overlap area 30A to be overlapped with the coupling 30 of the ground terminal 10B when the ground terminals 10A, 10B are assembled, and the contact portion 36 is arranged in this overlap area 30A. According to this configuration, the contact portion 36 is surrounded by areas of the main bodies 20, the wire connecting portions 40 and the coupling portions 30 of the ground terminals 10A, 10B other than the overlap area 30A. Thus, even if a plurality of terminal member assemblies 1 collide with each other, such as during the transportation of the terminal member assemblies 1, a possibility of the contact portion 36 to directly receive an impact can be reduced and a reduction of electrical connection reliability between the ground terminals due to the deformation of the contact portion 36 can be avoided.

Further, the ground terminal 10A includes the reinforcing portion 35 and the contact portion 36 is connected to the reinforcing portion 35. According to this configuration, since the contact portion 36 is connected to the reinforcing portion 35, the contact portion 36 and the reinforcing portion 35 can be formed in the same operation step and a manufacturing process can be simplified.

The technique disclosed by this specification is not limited to the above described and illustrated embodiment. For example, the following various modes are also included.

Although the terminal member assembly 1 is formed by assembling the two ground terminals 10A, 10B in the above embodiment, a terminal member assembly may be formed by assembling three or more terminal fittings.

Although the two ground terminals 10A, 10B constituting the terminal member assembly 1 are identically shaped in the above embodiment, all of a plurality of terminal fittings constituting a terminal member assembly may not be identically shaped. For example, a rotation stopping portion for stopping rotation relative to a body may be arranged on a terminal fitting adjacent to the body.

Although both of the two ground terminals 10A, 10B constituting the terminal member assembly 1 include the contact portion in the above embodiment, some of a plurality of terminal fittings constituting a terminal member assembly may include a contact portion.

Although the terminal fittings are the ground terminals in the above embodiment, the terminal fittings may not be ground terminals.

### LIST OF REFERENCE SIGNS

1 . . . terminal member assembly
10A . . . ground terminal (terminal fitting)
10B . . . ground terminal (terminal fitting)
20 . . . main body portion
30 . . . coupling portion
30A . . . overlap area
35 . . . reinforcing portion
36 . . . contact portion
40 . . . wire connecting portion

1. A terminal member assembly, comprising:
a plurality of terminal fittings each including a main body in the form of a flat plate, a coupling in the form of a flat plate extending from the main body and arranged on the same plane as the main body and a wire connecting portion connected to an extending end of the coupling, the plurality of terminal fittings being assembled with each other with the main bodies overlapping each other,
wherein at least one of the plurality of terminal fittings includes:
an overlap area to be overlapped with the coupling of an adjacent other terminal fitting, the overlap area being located on a surface of the coupling facing the other terminal fitting; and
a contact portion located in the overlap area, projecting toward a surface of the coupling of the other terminal fitting facing the one terminal fitting and configured to contact the coupling of the other terminal fitting.

2. The terminal member assembly of claim 1, wherein:
the one terminal fitting includes a reinforcing portion arranged on the coupling and projecting toward the other terminal fitting; and
the contact portion is connected to the reinforcing portion.
